(19) United States
(12) Patent Application Publication
(10) Pub. No.: US 2026/0340515 A1
(43) Pub. Date: Oct. 29, 2026

(54) Knowledge Distillation with Interleaved Sampling

(71) Applicant: GDM Holding LLC, Mountain View, CA (US)

(72) Inventors: Wenda Xu, Mountain View, CA (US); Rujun Han, Sunnyvale, CA (US); Zifeng Wang, Los Angeles, CA (US); Long Thanh Le, Sunnyvale, CA (US); Dhruv Madeka, New York, NY (US); Rishabh Agarwal, Montreal (CA); Chen-Yu Lee, Cupertino, CA (US); Tomas Jon Pfister, Redwood City, CA (US)

(21) Appl. No.: 19/188,612

(22) Filed: Apr. 24, 2025

(51) Int. Cl. G06N 20/20

(52) U.S. Cl. CPC G06N 20/20

(57) ABSTRACT

A computing system can train a machine-learned model by performing a plurality of training iterations. At each iteration, the computing system can provide an input context to each of a first and second machine-learned model, and can receive first and second probability distributions over a token vocabulary from the first and second machine-learned model respectively. At each iteration, the computing system can determine, based at least in part on the second probability distribution, whether to include first output tokens determined based on the first probability distribution in the input context at a next iteration of the plurality of training iterations.

### BACKGROUND

The present disclosure relates generally to machine learning processes and machine-learned devices and systems. A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include, for each of a plurality of training iterations, providing, by a computing system comprising one or more computing devices to each of a first machine-learned model and a second machine-learned model, an input context. The example method can include, for each of the plurality of training iterations, receiving, by the computing system from the first machine-learned model, a first probability distribution comprising a plurality of respective first probabilities associated with a plurality of respective tokens of a token vocabulary. The example method can include, for each of the plurality of training iterations, receiving, by the computing system from the second machine-learned model, a second probability distribution comprising a plurality of respective second probabilities associated with the plurality of respective tokens of the token vocabulary. The example method can include, for each of the plurality of training iterations, determining, by the computing system based at least in part on the second probability distribution, whether to include one or more first output tokens determined based on the first probability distribution in the input context at a next iteration of the plurality of training iterations. The example method can include, for each of the plurality of training iterations, performing at least one of: adding, to the input context by the computing system responsive to determining that the one or more first output tokens should not be included in the input context at the next iteration, one or more second tokens different from the one or more first output tokens; and adding, to the input context by the computing system responsive to determining that the one or more first output tokens should be included in the input context at the next iteration, the one or more first output tokens.

The example method can include updating, at one or more of the plurality of training iterations, by the computing system based at least in part on a comparison between the first probability distribution and second probability distribution, the first machine-learned model.

In the example method, updating the first machine-learned model can include updating based on a metric of divergence between the first probability distribution and the second probability distribution.

In the example method, determining whether to include the one or more first output tokens in the input context at the next iteration can include one or more of: comparing, by the computing system, a ranking of the one or more first output tokens within the second probability distribution to a ranking threshold; and comparing, by the computing system, a probability associated with the one or more first output tokens in the second probability distribution to a probability threshold.

In the example method, the one or more second tokens can be determined by sampling, by the computing system, the one or more second tokens from the second probability distribution.

In the example method, the one or more second tokens can be determined by: sampling, by the computing system, the one or more second tokens from the first probability distribution; and determining, by the computing system based at least in part on the second probability distribution, whether to include the one or more second tokens in the input context at the next iteration.

In the example method, the first machine-learned model can be a model that has been pretrained based on a first training dataset prior to the plurality of training iterations.

In the example method, the first machine-learned model can be a model that has been further trained based on a second training dataset prior to the plurality of training iterations.

The example method can include performing two or more training iterations of the plurality of training iterations in parallel. In the example method, performing two or more training iterations in parallel can include generating, by the first machine-learned model based at least in part on the input context, a sequence comprising a plurality of candidate output tokens associated with the two or more training iterations. In the example method, performing two or more training iterations in parallel can include generating, by the second machine-learned model based on the sequence, a plurality of second probability distributions in parallel. In the example method, performing two or more training iterations in parallel can include determining, by the computing system based at least in part on the plurality of second probability distributions, whether to include a first candidate output token of the plurality of candidate output tokens in the input context at a later iteration of the plurality of training iterations. In the example method, performing two or more training iterations in parallel can include performing at least one of: determining, by the computing system responsive to determining that the first candidate output token should be included in the input context at the later iteration, based at least in part on the plurality of second probability distributions, whether to include a second candidate output token of the plurality of candidate output tokens in the input context at the later iteration; and discarding, by the computing system responsive to determining that the first candidate output token should not be included in the later iteration, the first candidate output token and the second candidate output token.

In the example method, the first machine-learned model can be characterized by a first number of parameters. In the example method, the second machine-learned model can be characterized by a second number of parameters. In the example method, the second number of parameters can be larger than the first number of parameters.

In the example method, the second number of parameters can be at least three times the first number of parameters.

Example aspects of the present disclosure provide an example computing system that includes one or more processors and one or more example non-transitory computer-readable media storing instructions that are executable by one or more processors to cause a computing system to perform example operations. In some implementations, the example operations can include, for each of a plurality of training iterations, providing, to each of a first machine-learned model and a second machine-learned model, an input context. The example operations can include, for each of the plurality of training iterations, receiving, from the first machine-learned model, a first probability distribution comprising a plurality of respective first probabilities associated with a plurality of respective tokens of a token vocabulary. The example operations can include, for each of the plurality of training iterations, receiving, from the second machine-learned model, a second probability distribution comprising a plurality of respective second probabilities associated with the plurality of respective tokens of the token vocabulary. The example operations can include, for each of the plurality of training iterations, determining, based at least in part on the second probability distribution, whether to include one or more first output tokens determined based on the first probability distribution in the input context at a next iteration of the plurality of training iterations. The example operations can include, for each of the plurality of training iterations, performing at least one of: adding, to the input context responsive to determining that the one or more first output tokens should not be included in the input context at the next iteration, one or more second tokens different from the one or more first output tokens; and adding, to the input context responsive to determining that the one or more first output tokens should be included in the input context at the next iteration, the one or more first output tokens.

The example operations can include updating, at one or more of the plurality of training iterations based at least in part on a comparison between the first probability distribution and second probability distribution, the first machine-learned model.

In the example operations, updating the first machine-learned model can include updating based on a metric of divergence between the first probability distribution and the second probability distribution.

In the example operations, determining whether to include the one or more first output tokens in the input context at the next iteration can include one or more of: comparing a ranking of the one or more first output tokens within the second probability distribution to a ranking threshold; and comparing a probability associated with the one or more first output tokens in the second probability distribution to a probability threshold.

In the example operations, the one or more second tokens can be determined by sampling the one or more second tokens from the second probability distribution.

In the example operations, the one or more second tokens can be determined by: sampling the one or more second tokens from the first probability distribution; and determining, based at least in part on the second probability distribution, whether to include the one or more second tokens in the input context at the next iteration.

The example operations can include performing two or more training iterations of the plurality of training iterations in parallel. In the example operations, performing two or more training iterations in parallel can include generating, by the first machine-learned model based at least in part on the input context, a sequence comprising a plurality of candidate output tokens associated with the two or more training iterations. In the example operations, performing two or more training iterations in parallel can include generating, by the second machine-learned model based on the sequence, a plurality of second probability distributions in parallel. In the example operations, performing two or more training iterations in parallel can include determining, by the computing system based at least in part on the plurality of second probability distributions, whether to include a first candidate output token of the plurality of candidate output tokens in a later iteration of the plurality of training iterations. In the example operations, performing two or more training iterations in parallel can include performing at least one of: determining, responsive to determining that the first candidate output token should be included in the input context at the later iteration, based at least in part on the plurality of second probability distributions, whether to include a second candidate output token of the plurality of candidate output tokens in the input context at the later iteration; and discarding, responsive to determining that the first candidate output token should not be included in the later iteration, the first candidate output token and the second candidate output token.

In the example operations, the first machine-learned model can be characterized by a first number of parameters. In the example operations, the second machine-learned model can be characterized by a second number of parameters. In the example operations, the second number of parameters can be larger than the first number of parameters.

Example aspects of the present disclosure provide one or more example non-transitory computer-readable media storing instructions that are executable by one or more processors to cause a computing system to perform example operations. In some implementations, the example operations can include, for each of a plurality of training iterations, providing, to each of a first machine-learned model and a second machine-learned model, an input context. The example operations can include, for each of the plurality of training iterations, receiving, from the first machine-learned model, a first probability distribution comprising a plurality of respective first probabilities associated with a plurality of respective tokens of a token vocabulary. The example operations can include, for each of the plurality of training iterations, receiving, from the second machine-learned model, a second probability distribution comprising a plurality of respective second probabilities associated with the plurality of respective tokens of the token vocabulary. The example operations can include, for each of the plurality of training iterations, determining, based at least in part on the second probability distribution, whether to include one or more first output tokens determined based on the first probability distribution in the input context at a next iteration of the plurality of training iterations. The example operations can include, for each of the plurality of training iterations, performing at least one of: adding, to the input context responsive to determining that the one or more first output tokens should not be included in the input context at the next iteration, one or more second tokens different from the one or more first output tokens; and adding, to the input context responsive to determining that the one or more first output tokens should be included in the input context at the next iteration, the one or more first output tokens.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system for knowledge distillation according to example implementations of aspects of the present disclosure;

FIG. 2 is a block diagram of an example system for determining a next token for use in a knowledge distillation training process according to example implementations of aspects of the present disclosure;

FIG. 3 is a block diagram of an example system for next token determination according to example implementations of aspects of the present disclosure;

FIG. 4 depicts a flowchart diagram of an example method for performing an iteration of a multi-iteration training process according to example embodiments of the present disclosure;

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

Generally, the present disclosure is directed to systems and methods for training a “student” machine-learned sequence processing model (e.g., language model, multimodal model, etc.) based on feedback from a “teacher” machine-learned sequence processing model. For each of a plurality of training iterations, a student model and teacher model can each receive an input context and generate one or more outputs. During one or more of the training iterations, a computing system can update the student model based on a comparison between the student output(s) and teacher output(s). This process can be referred to as knowledge distillation.

In some instances, an input context at a later iteration can include an output sequence (e.g., sequence of words or tokens such as a sentence or paragraph, etc.) that is generated collaboratively by the student and teacher model. For example, at a first training iteration, a computing system can determine, based on the student model output(s), a candidate output token (e.g., word, letter, audio phoneme, video sequence token, etc.). The computing system can then determine, based on the teacher probability distribution, whether to accept or reject the candidate output token. Accepted tokens can be added to a sequence being collaboratively built by the student and teacher models, whereas rejected tokens can be replaced in the sequence by an alternative token determined based on the teacher output(s). The collaborative sequence can then be included in the input context in the next training iteration. In this manner, for instance, the student model can spend more training iterations learning about contexts that a well-trained student is likely to encounter, and fewer training iterations learning about contexts the student would be unlikely to encounter independently or contexts that only an untrained or poorly trained student would be likely to encounter.

In some instances, a student output or teacher output can include a distribution over an output vocabulary. For example, in some instances, a teacher model and student model can each receive an input context; and generate, based on the input context, a probability distribution comprising a plurality of respective probabilities for respective tokens (e.g., words, etc.) of an output vocabulary. In some instances, a computing system can update the student model based on a metric of similarity between a student probability distribution and a teacher probability distribution generated from the same input context. For example, in some instances, updating the student model can include updating based on an objective function (e.g., loss function, etc.) comprising a metric of divergence (e.g., Kullback-Leibler divergence, etc.) between a student probability distribution and a teacher probability distribution. As another example, in some instances, determining a candidate output token or replacement output token can include sampling from a teacher or student probability distribution.

In some instances, determining whether to accept or reject a candidate output token can include comparing the candidate output token to a teacher probability distribution. For example, in some instances, determining whether to accept or reject a candidate output token can include identifying a top k most probable output tokens of the teacher probability distribution, where k is a positive integer (e.g., 25, 50, etc.). Continuing the example, student-generated candidate tokens that are among the top k tokens of the teacher distribution can be accepted, and candidate tokens that are not among the top k can be rejected. As another example, in some instances, a respective probability of the candidate token within the teacher probability distribution can be identified, and the token can be accepted if the respective probability is above a probability threshold and rejected otherwise. Other examples are possible.

In some instances, the student model can be initialized according to an initial training process before being further trained by the teacher model. For example, in some instances, a student can be pretrained based on a general-purpose training dataset, such as a training dataset comprising general-purpose language data or multimodal data (e.g., vision and language data, visual and audio data, text and audio data, etc.) collected from a wide variety of sources. As another example, in some instances, a student can be fine-tuned (e.g., after pretraining) on a specialized training dataset, such as a task-specific dataset associated with a specialized task. For example, in some instances, a teacher model can include an expert model that has already been trained (e.g., fine-tuned, etc.) using one or more task-specific datasets, and the student model can be fine-tuned on a task-specific dataset associated with a similar (e.g., same, etc.) task before distillation. However, this is not required, and a student model can be initialized in any manner without deviating from the scope of the present disclosure.

In some instances, the teacher model can evaluate a plurality of input contexts in parallel according to a speculative decoding process. For example, in some instances, a student model can generate a candidate sequence comprising two or more (e.g., three, five, etc.) consecutive candidate output tokens. Continuing the example, in some instances, the teacher model can evaluate, in parallel, two or more input contexts associated with the candidate sequence, such as a first context comprising the first token of the candidate sequence; a second context comprising the first two tokens of the candidate sequence; a third context comprising the first three tokens of the candidate sequence; or the like. A computing system can then compare (e.g., in parallel, etc.) each of the two or more candidate outputs to the teacher output(s) generated based on the two or more input contexts, and can determine whether to accept or reject each of the candidate outputs. In some instances, the computing system can update the student model based on output(s) generated from accepted candidate token(s) (e.g., without updating the student model based on output(s) generated from rejected candidate token(s), etc.). Other implementations are possible.

In some instances, the teacher model can include a model having a higher computational cost or higher complexity than the student model, such as a teacher having a larger number of parameters than the student model; a larger memory footprint, storage footprint, or memory bandwidth requirement than the student model; a larger number of floating-point operations (flops) per inference compared to the student model; or otherwise having a greater computational cost or complexity. In some instances, a number of parameters of the teacher model can be greater than twice a number of parameters of the student model, such as greater than three times the number of parameters, such as greater than five times, ten times, 25 times, 50 times, or the like. Similarly, in some instances, a storage footprint, number of flops per inference, or other metric of computational complexity of the teacher model can be greater than twice a corresponding metric of computational complexity of the student model, such as greater than three times, five times, ten times, 25 times, 50 times, or the like.

Systems and methods according to some aspects of the present disclosure can provide a variety of technical effects and benefits, such as improvements to computing technology (e.g., machine learning technology). For example, in some instances, student models trained according to aspects of the present disclosure can provide better technical performance (e.g., higher inference accuracy, etc.) for a given computational cost compared to some alternative implementations. As another example, in some instances, systems and methods according to some aspects of the present disclosure can provide similar (e.g., same, etc.) technical performance at a reduced computational cost (e.g., electricity cost, processor usage, memory usage, time cost, etc.) compared to some alternative implementations.

In some instances, student models trained according to aspects of the present disclosure can provide better technical performance (e.g., higher inference accuracy, etc.) for a given computational cost compared to some alternative implementations. For example, in some example experiments according to aspects of the present disclosure, student models distilled according to example methods described herein achieved better task-specific performance (e.g., higher COMET scores, higher ROUGE-L scores, higher accuracy scores, etc.) on a variety of test tasks (e.g., translation, summarization, mathematical word problems, etc.) compared to student models distilled according to some alternative methods, and compared to student models that were fine-tuned but not distilled. This improved performance was achieved in various experimental conditions, such as with fine-tuned or non-fine-tuned student model initializations; and in small-dataset (e.g., 100 data examples per task, etc.) and large-dataset conditions. As another example, in some example experiments according to aspects of the present disclosure, students distilled on example multi-task datasets according to example methods described herein outperformed students distilled on the same multi-task datasets according to some alternative distillation methods (e.g., alternative distillation methods based on sequences that are entirely student-generated or entirely teacher-generated; alternative distillation methods based on random interleaving of student and teacher tokens; etc.). Further details of some example experiments are provided in Xu et al., Speculative Knowledge Distillation: Bridging the Teacher-Student Gap Through Interleaved Sampling, available at https://arxiv.org/pdf/2410.11325.

As another example, in some instances, systems and methods according to some aspects of the present disclosure can provide similar (e.g., same, etc.) technical performance at a reduced computational cost (e.g., electricity cost, processor usage, memory usage, etc.) compared to some alternative implementations. For example, in some instances, systems and methods that can provide improved technical performance at a given computational cost (e.g., electricity cost, processor usage, memory usage, etc.) can be adapted to provide a given technical performance (e.g., given accuracy on a mathematical task, etc.) at reduced computational cost compared to some alternative implementations. For example, in some instances, an accuracy of a machine-learned model, and a cost of running the machine-learned model, can scale with a size (e.g., number of parameters, etc.) or complexity of the machine-learned model. In such instances, reducing a size or complexity of the model can reduce a cost of running the machine-learned model. In this manner, for instance, a reduced-size student model trained according to example implementations of aspects of the present disclosure can in some instances achieve similar (e.g., same) performance at reduced computational cost compared to a larger student model trained according to some alternative implementations (e.g., on-policy knowledge distillation, supervised knowledge distillation, etc.), thereby improving the functioning of the computing system and machine learning training technology.

As another example, in some instances, an accuracy of a trained (e.g., distilled, etc.) machine-learned model can in some instances scale with a number of training iterations used to train (e.g., distill, etc.) the machine-learned model. In such instances, reducing a number of training iterations used to train the machine-learned model can reduce a training cost (e.g., computational cost, electricity cost, memory usage, time cost, etc.) of training the machine-learned model (while also reducing the accuracy of the trained model in some instances). In this manner, for instance, a student model trained using fewer iterations according to some aspects of the present disclosure can in some instances provide similar technical performance (e.g., inference accuracy, etc.) at reduced training cost compared to a student model trained using more training iterations according to some alternative implementations (e.g., supervised knowledge distillation, on-policy knowledge distillation, etc.), thereby improving the functioning of the computing system and machine learning training technology. As another example, in some instances, systems and methods according to some aspects of the present disclosure can reduce a time cost of training a machine-learned model, such as by reducing a number of training iterations required to achieve a given level of technical performance (e.g., inference accuracy, etc.) or by increasing a level of parallelism in a distillation process, thereby reducing an amount of time (e.g., wall clock time, etc.) required to perform a given number of training iterations in some instances.

Various example implementations are described herein with respect to the accompanying Figures.

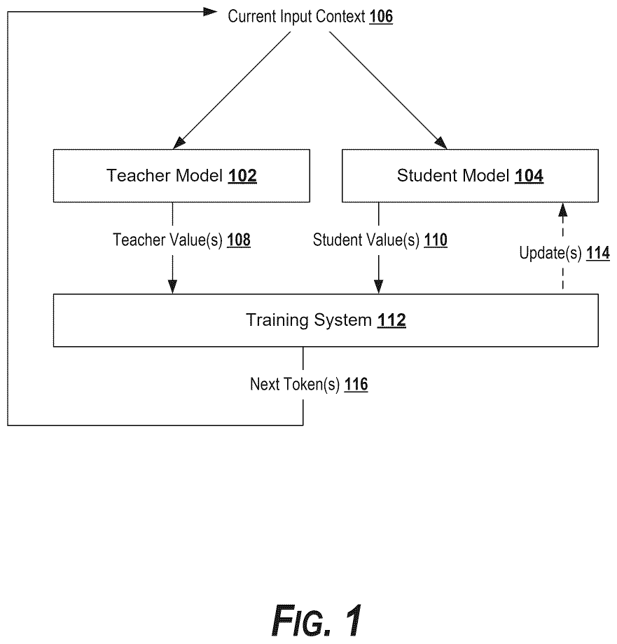

FIG. 1 is a block diagram of an example system for knowledge distillation according to example implementations of aspects of the present disclosure. A teacher model 102 and student model 104 can each receive a current input context 106. Based on the current input context 106, the teacher model 102 can generate one or more teacher output values 108. Similarly, based on the current input context 106, the student model 104 can generate one or more student output values 110. Based at least in part on the student value(s) 110 and teacher value(s) 108, the training system 112 can determine one or more next tokens 116 to be included in the current input context 106 at a next iteration of a knowledge distillation training process. Additionally, in some instances, the training system 112 can provide one or more updates 114 to the student model 104 based on a comparison between one or more teacher values 108 and corresponding student values 110. For example, in some instances, a sequence comprising a plurality of next tokens 116 can be generated based on a plurality of teacher values 108 and student values 110, and one or more updates 114 can be performed at an end of the sequence.

The teacher model 102 can include one or more machine-learned models. The teacher model 102 can include various model architectures, such as various neural network model architectures. An example model architecture for a teacher model 102 can include a sequence processing model architecture (e.g., a transformer model). For example, the teacher model 102 can be configured to receive an input sequence and generate an output sequence. For instance, the teacher model 102 can be configured to generate an output sequence where elements of the output sequence are predicted based on the elements of the input sequence. In some instances, a teacher model 102 can include a model architecture having an attention mechanism (e.g., self-attention). In some instances, the teacher model 102 can be a pre-trained model (e.g., pretrained using large-scale unsupervised learning). In some instances, the teacher model 102 can be fine-tuned over one or more fine-tuning datasets, such as a fine-tuning dataset associated with one or more specialized generation tasks.

In some instances, the teacher model 102 can include a machine-learned sequence processing model (e.g., language model, multimodal model, etc.). In some instances, a teacher model 102 can include a machine-learned sequence processing model configured to receive, as input, one or more of: text data (e.g., natural language text data, computer code data, structured text data such as JSON-structured text data, etc.), natural language data (e.g., text data, speech data, etc.), or other input type. In some instances, a multimodal teacher model 102 can include a machine-learned sequence processing model configured to provide, as output, one or more of: text data (e.g., natural language text data, computer code data, structured text data such as JSON-structured text data, etc.), natural language data (e.g., text data, speech data, etc.), or other input type.

The student model 104 can include one or more machine-learned models. The student model 104 can include various model architectures, such as various neural network model architectures. An example model architecture for a student model 104 can include a sequence processing model architecture (e.g., a transformer model). For example, the student model 104 can be configured to receive an input sequence and generate an output sequence. For instance, the student model 104 can be configured to generate an output sequence where elements of the output sequence are predicted based on the elements of the input sequence. In some instances, a student model 104 can include a model architecture having an attention mechanism (e.g., self-attention). In some instances, the student model 104 can be a pre-trained model (e.g., pretrained using large-scale unsupervised learning). In some instances, the student model 104 can be fine-tuned over one or more fine-tuning datasets, such as a fine-tuning dataset associated with one or more specialized generation tasks.

In some instances, the student model 104 can include a machine-learned sequence processing model (e.g., language model, multimodal model, etc.). In some instances, a student model 104 can include a machine-learned sequence processing model configured to receive, as input, one or more of: text data (e.g., natural language text data, computer code data, structured text data such as JSON-structured text data, etc.), natural language data (e.g., text data, speech data, etc.), or other input type. In some instances, a student model 104 can include a machine-learned sequence processing model configured to provide, as output, one or more of: text data (e.g., natural language text data, computer code data, structured text data such as JSON-structured text data, etc.), natural language data (e.g., text data, speech data, etc.), or other input type.

The teacher model 102 can be the same as or different from the student model 104. In some instances, the teacher model 102 can use one or more model components or model architectures of the student model 104. In some instances, the teacher model 102 be entirely different from the student model 104. The teacher model 102 can be larger than the student model 104. In some instances, the student model 104 can have a number of parameters that is smaller (e.g., 2 times, 3 times, 5 times, 10 times, 20 times, 30 times, 50 times, 100 times smaller, etc.) than a number of parameters of the teacher model 108. In some instances, the student model 104 can be characterized by a computing cost (e.g. inference cost, pretraining cost, fine-tuning cost, memory usage, etc.) that is lower than a computing cost of the teacher model 108.

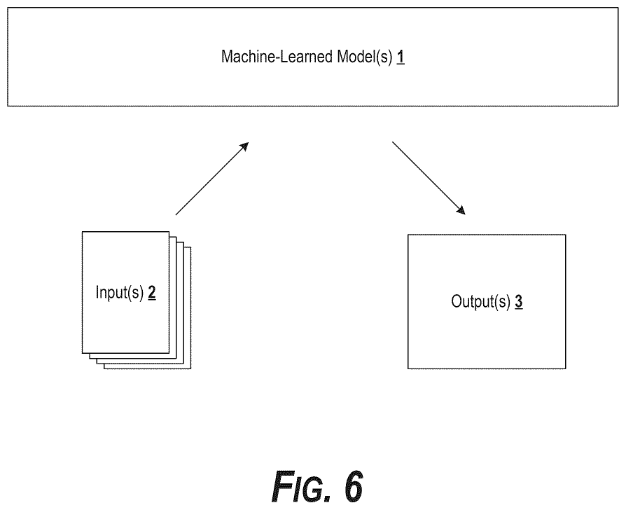

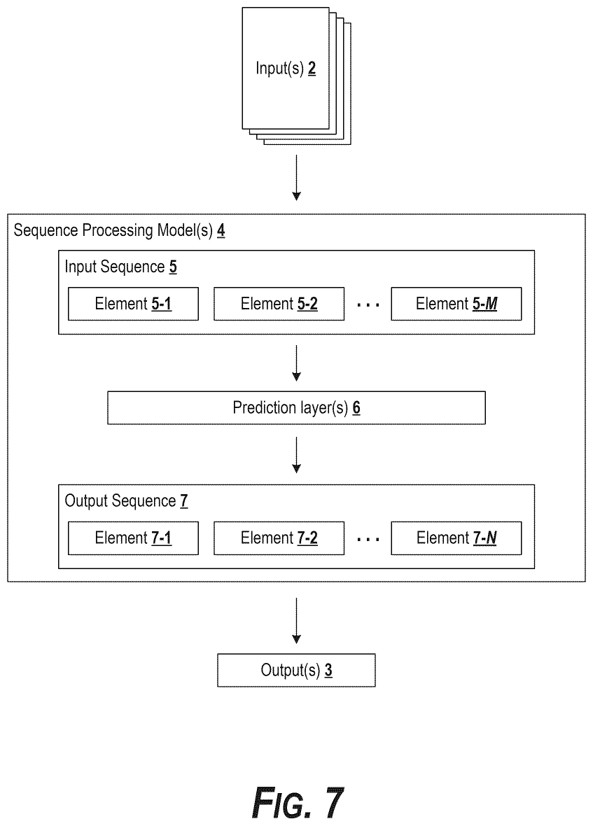

A current input context 106 can generally include or otherwise represent various types of data. A current input context 106 can include one type or many different types of data. Example data types for a current input context 106 can include, for example, any data type described below with respect to FIGS. 6-7 and inputs 2, such as language data (e.g., natural language data such as text or speech data, programming language data, etc.), sequence data (e.g., language sequence, time series, etc.), image data, audio data, video data, or another data type. In some instances, a current input context 106 can provide context for one or more predictions by student model 104 or teacher model 102. For instance, one or more predictions by student model 104 or teacher model 102 can be conditioned on context data in current input context 106.

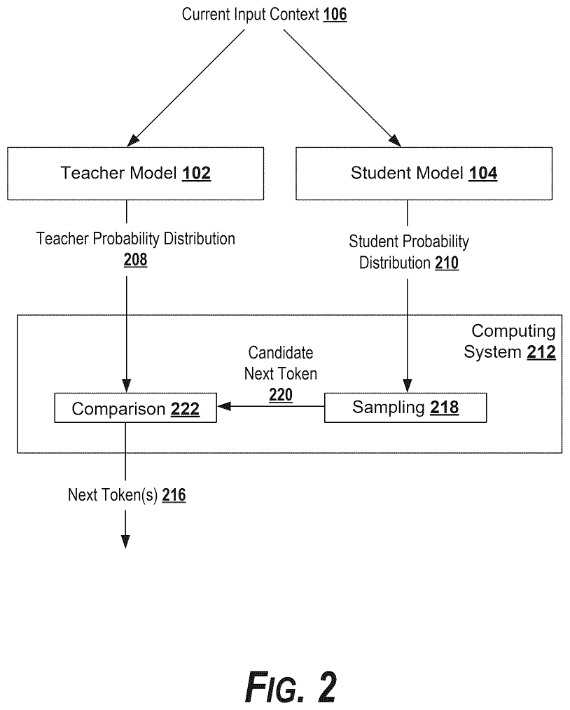

Teacher value(s) 108 can generally include or otherwise represent various types of data. A teacher value 108 can include one type or many different types of data. A teacher value 108 can include one or more data types that are similar to (e.g., same as) or different from one or more data types of a current input context 106. Example data types for a teacher value 108 can include, for example, numerical data indicative of one or more numerical values (e.g., probability distribution comprising a plurality of probability values, etc.); token data or sequence data indicative of all or part of a sequence processing output; or one or more data types described below with respect to FIGS. 6-7 and inputs 2. Further details of example teacher value(s) 108 comprising probability distributions according to some aspects of the present disclosure are provided below with respect to FIG. 2.

The teacher value(s) 108 can be or be based on any value(s) generated by the teacher model 102. The teacher value(s) 108 can be final output values or intermediate output values. For example, for a teacher model 102 configured for natural language processing, a final output value can be a word and an intermediate output value can be a probability associated with that word. For example, more generally, a teacher model 102 can be configured with a set of candidate outputs (e.g., a vocabulary, a set of classes/categories, tokens, other output element(s), etc.), such that a final output value can be the output element itself (e.g., the word in the vocabulary, the class label, an image mask, etc.) and an intermediate output value can be one or more probabilities distributed over the set of candidate outputs. In general, the teacher model 102 can generate various different final outputs and various different intermediate output values. In an example, intermediate output values can reflect the internal decision-making of the student model 104 while the final output values can reflect the final decision of the teacher model 102 (e.g., with respect to a prediction, etc.). In some instances, a teacher value 108 can include an activation value generated by any layer of a teacher model 102, such as an embedding value generated by an intermediate layer; a probability value generated by an intermediate layer or output layer; or the like.

In some instances, teacher values 108 can include data in a format consistent with a format of student values 110 to facilitate comparison therebetween. In some instances, teacher values 108 can include data in a format consistent with input context 106 or in another format interpretable by the teacher model 102 or student model 104 (e.g., input format, embedding format, probability distribution format, etc.).

Student value(s) 110 can generally include or otherwise represent various types of data. A student value 110 can include one type or many different types of data. A student value 110 can include one or more data types that are similar to (e.g., same as) or different from one or more data types of a current input context 106 or teacher value(s) 108. Example data types for a student value 110 can include, for example, numerical data indicative of one or more numerical values (e.g., probability distribution comprising a plurality of probability values, etc.); token data or sequence data indicative of all or part of a sequence processing output; or one or more data types described below with respect to FIGS. 6-7 and inputs 2. Further details of example student value(s) 110 comprising probability distributions according to some aspects of the present disclosure are provided below with respect to FIG. 2.

The student value(s) 110 can be or be based on any value(s) generated by the student model 104. The student value(s) 110 can be final output values or intermediate output values. For example, for a student model 104 configured for natural language processing, a final output value can be a word and an intermediate output value can be a probability associated with that word. For example, more generally, a student model 104 can be configured with a set of candidate outputs (e.g., a vocabulary, a set of classes/categories, tokens, other output element(s), etc.), such that a final output value can be the output element itself (e.g., the word in the vocabulary, the class label, an image mask, etc.) and an intermediate output value can be one or more probabilities distributed over the set of candidate outputs. In general, the student model 104 can generate various different final outputs and various different intermediate output values. In an example, intermediate output values can reflect the internal decision-making of the student model 104 while the final output values can reflect the final decision of the student model 104 (e.g., with respect to a prediction, etc.). In some instances, a student value 110 can include an activation value generated by any layer of a student model 104, such as an embedding value generated by an intermediate layer; a probability value generated by an intermediate layer or output layer; or the like.

In some instances, student value(s) 110 can include data in a format consistent with a format of teacher values 108 to facilitate comparison therebetween. In some instances, student value(s) 110 can include data in a format consistent with input context 106 or in another format interpretable by the teacher model 102 or student model 104 (e.g., input format, embedding format, probability distribution format, etc.).

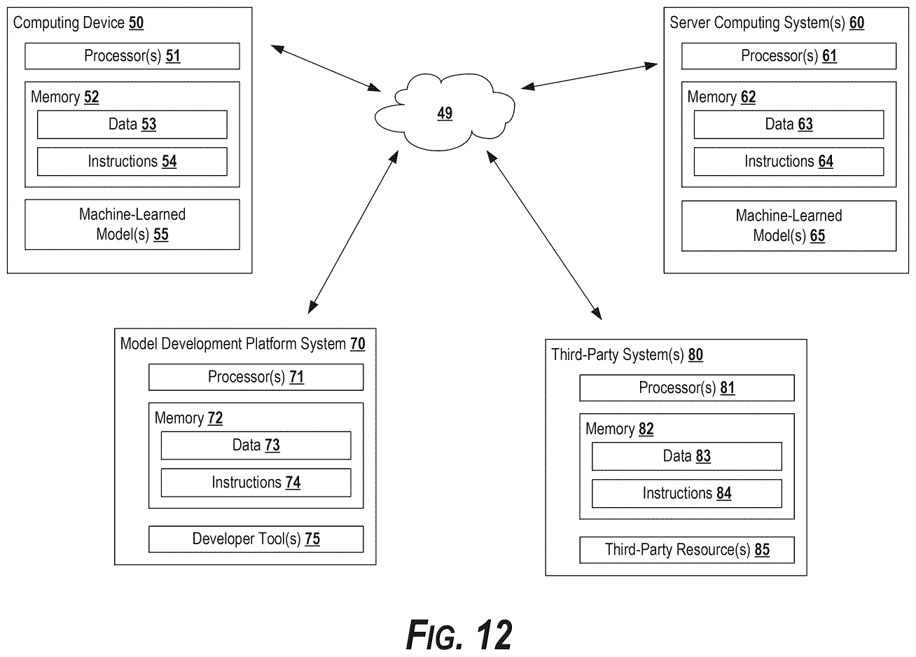

A training system 112 can be or include one or more software, firmware, or hardware components configured to determine update(s) 114 based on teacher value(s) 108 and student value(s) 110. In some instances, the training system 112 can be, comprise, be comprised by, or share one or more properties with a computing device or system described below with respect to FIGS. 12-14 (e.g., computing device 50, third-party system 80, computing device 98, computing device 99, etc.).

An update 114 can include, for example, a value (e.g., numerical value, etc.) for updating one or more parameters of the student model 104, an action for updating the student model 104, or the like. For example, in some instances, an update 114 value can include a numerical adjustment value to be combined with (e.g., added to, multiplied by, etc.) a parameter of the student model 104 to generate an updated parameter. In some instances, an update 114 can be determined based on an evaluation of one or more student values 110, such as evaluation using a loss function, reward function, or other objective function. For example, in some instances, student value(s) 110 can be compared to teacher value(s) 108 or another value (e.g., ground truth output value, etc.) according to a loss function. In some instances, a gradient of an objective function with respect to one or more training outputs (e.g., mini-batch comprising a plurality of loss values associated with a plurality of student values 110 or a plurality of training iterations, etc.) can be determined, and the update(s) 114 can be determined based on one or more gradients (e.g., by multiplying the gradient by a constant or adaptive learning rate parameter, etc.). Further details of some example methods for determining update 114 values and updating a machine-learned model are provided below, such as with respect to FIGS. 2, 5, and 10.

A next token 116 can generally include or otherwise represent various types of data. A next token 116 can include one type or many different types of data. Example data types for a next token 116 can include, for example, any data type described below with respect to FIGS. 6-7 and inputs 2, such as language data (e.g., natural language data such as text or speech data, programming language data, etc.), sequence data (e.g., language sequence, time series, etc.), image data, audio data, video data, or another data type.

In some instances, a next token 116 can include a token (e.g., language token or text token such as a word; etc.) to be included in a sequence comprising a plurality of tokens. For example, in some instances, a current input context 106 can include one or more sequences (e.g., text sequence(s), language sequence(s), audio sequence(s), video sequence(s), etc.), and a next token 116 can include a token to be included (e.g., appended, concatenated, etc.) in the sequence(s) at a later training iteration of a plurality of training iterations. For example, in some instances, a current input context 106 provided at a current training iteration can include an initial input context, along with zero or more (e.g., a plurality of, etc.) next token(s) 116 generated by the student model 104 or teacher model 102 based on the initial input context at zero or more (e.g., a plurality of, etc.) prior training iterations of a plurality of training iterations. In this manner, for example, across multiple iterations, the student model 104 can process, as context, prior outputs of the student model 104 or teacher model 102, thereby generating new outputs conditioned on the prior outputs. In this manner, for example, the student model 104 and teacher model 102 together can autoregressively generate multiple output values to form an output sequence.

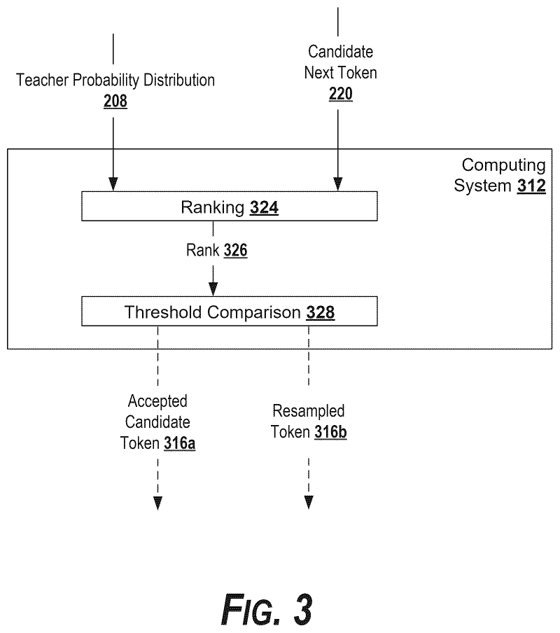

In some instances, determining a next token 116 can include selecting a candidate next token based at least in part on student value(s) 108, and determining whether to accept or reject the candidate next token based at least in part on the teacher value(s) 110. In some instances, responsive to rejecting a candidate next token, determining a next token 116 can include determining a replacement token. In some instances, determining a replacement token can include determining a replacement token based on the teacher value(s) 110; determining a candidate replacement token based on the student value(s) 108 and determining whether to accept or reject the candidate replacement token based on the teacher value(s) 110; determining the replacement token based on a combination of teacher value(s) 108 and student value(s) 110; or other method. Further details of some example systems for determining next token(s) 116 are provided below with respect to FIGS. 2 and 3.

FIG. 2 is a block diagram of an example system for determining a next token for use in a knowledge distillation training process according to example implementations of aspects of the present disclosure. A teacher model 102 and student model 104 can each receive a current input context 106. Based on the current input context 106, the teacher model 102 can generate a teacher probability distribution 208. Similarly, based on the current input context 106, the student model 104 can generate a student probability distribution 210. A computing system 212 can perform a sampling 218 operation to sample a candidate next token 220 from the student probability distribution 210. Based on a comparison 222 between the candidate next token 220 and the teacher probability distribution 208, the computing system 212 can determine a next token 216. For example, in some instances, determining a next token 216 can include determining whether to accept the candidate next token 220 as the next token 216, or whether to reject the candidate next token 220 and determine a different next token 216.

In some instances, a teacher probability distribution 208 can be, comprise, be comprised by, or otherwise share one or more properties with teacher value(s) 108. For example, in some instances, a teacher probability distribution 208 can have any property described herein with respect to teacher value(s) 108, and vice versa.

The teacher probability distribution 208 can reflect internal decision-making of the teacher model 102 regarding current input context 116. For instance, the teacher probability distribution 208 can indicate probability values associated with one or more possible output values of the teacher model 102 conditioned on current input context 116. For example, a teacher model 102 can be configured to generate an output selected from a set of candidate outputs. The selected output can be selected based on the teacher probability distribution 208.

For example, the teacher probability distribution 208 can indicate a score or value generated by the teacher model 102 that indicates a goodness of a given output candidate with respect to the current input context 116. The teacher probability distribution 208 can reflect a relative evaluation of the output candidates, such that a particular candidate can be selected by comparison with the values or scores for the other candidates.

In some instances, the teacher probability distribution 208 can correspond to a discrete probability distribution or continuous distribution (e.g., a probability distribution function). In some instances, the teacher probability distribution 208 can have a plurality of subdivisions. In some instances, the subdivisions can correspond to a plurality of members of an output vocabulary of the teacher model 102. In some instances, the teacher probability distribution 208 can include one or more values (e.g., probability values). In some instances, a respective value of the teacher probability distribution 208 can include or correspond to a respective prediction (e.g., next token prediction, masked language prediction, expected output prediction). Thus, in some instances, the teacher probability distribution 208 can be a discrete probability distribution characterized by a plurality of probability values (e.g., predictions) associated respectively with a plurality of vocabulary words.

For example, the teacher probability distribution 208 can be a probability distribution P over an output space S. The probability values P can be generated by the teacher model 102. The probability values P can be generated by the student model 104 based on the current input context 116. The probability value for a particular value s E S can indicate a likelihood of the value s based on the current input context 116. The probability value for a particular value s E S can indicate a likelihood of the value s follows the current input context 116 in a combined sequence (e.g., a context window).

In some instances, a student probability distribution 210 can be, comprise, be comprised by, or otherwise share one or more properties with student value(s) 110. For example, in some instances, a student probability distribution 210 can have any property described herein with respect to student value(s) 110, and vice versa.

The student probability distribution 210 can reflect internal decision-making of the student model 104 regarding current input context 116. For instance, the student probability distribution 210 can indicate probability values associated with one or more possible output values of the student model 104 conditioned on current input context 116. For example, a student model 104 can be configured to generate an output selected from a set of candidate outputs. The selected output can be selected based on the student probability distribution 210.

For example, the student probability distribution 210 can indicate a score or value generated by the student model 104 that indicates a goodness of a given output candidate with respect to the current input context 116. The student probability distribution 210 can reflect a relative evaluation of the output candidates, such that a particular candidate can be selected by comparison with the values or scores for the other candidates.

In some instances, the student probability distribution 210 can correspond to a discrete probability distribution or continuous distribution (e.g., a probability distribution function). In some instances, the student probability distribution 210 can have a plurality of subdivisions. In some instances, the subdivisions can correspond to a plurality of members of an output vocabulary of the student model 104. In some instances, the student probability distribution 210 can include one or more values (e.g., probability values). In some instances, a respective value of the student probability distribution 210 can include or correspond to a respective prediction (e.g., next token prediction, masked language prediction, expected output prediction). Thus, in some instances, the student probability distribution 210 can be a discrete probability distribution characterized by a plurality of probability values (e.g., predictions) associated respectively with a plurality of vocabulary words.

For example, the student probability distribution 210 can be a probability distribution P over an output space S. The probability values P can be generated by the student model 104. The probability values P can be generated by the student model 104 based on the current input context 116. The probability value for a particular value s∈S can indicate a likelihood of the value s based on the current input context 116. The probability value for a particular value s∈S can indicate a likelihood of the value s follows the current input context 116 in a combined sequence (e.g., a context window).

Similarly, the teacher probability distribution 208 can be a distribution generated based on current input context 116. In this manner, for example, teacher probability distribution 208 can represent the reasoning of the teacher model 102 in view of the same information available to the student model 104 when generating the student probability distribution 210. In this manner, for example, the teacher probability distribution 208 can directly correspond to or otherwise provide a reference point of comparison for the student probability distribution 210.

In some implementations, the teacher probability distribution 208 can be generated with a lower temperature setting as compared to a temperature setting used to generate the student probability distribution 210. For instance, a temperature parameter can affect a shape of the distribution. For example, the probability of predicting nth token y_n, p(y_n|x), can be determined using a softmax with temperature gamma:

$$p ( {y}_{n} \vert x ) = \frac{exp ( {z}_{n} / γ )}{{\sum }_{i = 1}^{M} exp ( {z}_{i} / γ )} ,$$

where z_n can be a logit score for a token y_n. Greedy sampling can correspond to a temperature of zero. Temperature sampling can correspond to a nonzero temperature.

Any one or more of the student or teacher distributions can be partial or complete distributions. For example, in some situations a full distribution over all the output space might not be known. For example, a top-K set of output values and their corresponding probabilities might be known. The distribution can be based on the top-K set. K can be 1 or more than 1 (e.g., 25, 50, etc.). In some instances, a teacher probability distribution 208 and student probability distribution 210 can include probability distributions over similar (e.g., same, etc.) vocabularies or different vocabularies (e.g., overlapping vocabularies, etc.). In some instances, a pair of probability distributions 208, 210 over two different vocabulary can be equivalent to a pair of probability distributions 208, 210 over a union of the two vocabularies, wherein each item outside of a first vocabulary can have a probability of zero with respect to a first probability distribution over the first vocabulary. In some instances, a probability distribution 208, 210 can include a plurality of values that sum to 1, or a plurality of numerical values that can be processed (e.g., normalized, processed according to a softmax operation, etc.) to generate a plurality of numerical values that sum to 1.

In some instances, a computing system 212 can be, comprise, be comprised by, or otherwise share one or more properties with a training system 112. For example, in some instances, a computing system 212 can have any property described herein with respect to a training system 112, and vice versa.

In some instances, an update 114 can be determined based on a comparison between a teacher probability distribution 208 and student probability distribution 210. For example, in some instances, an update 114 can be based at least in part on a metric of similarity between a teacher probability distribution 208 and student probability distribution 210. In some instances, a metric of similarity can include a metric of divergence. In some instances, an update 114 can be determined based at least in part on a gradient of an objective function (e.g., loss function, etc.) comprising a metric of similarity (e.g., metric of divergence, etc.).

In some instances, one or more metrics of divergence be computed based on individual values from the distributions 208, 210 (e.g., values drawn from discrete distributions) that are generated based on one or more portions of the current input context 116. For example, a student value 110 can be drawn from the student distribution 210 and a teacher value 108 can be drawn from the teacher distribution 208. These values can be compared and the comparisons aggregated over the distribution(s) to compute a total divergence value for the pair of distributions.

An example divergence metric uses a ratio of a student probability 210 value and a corresponding teacher probability 208 value. In some instances, computing the ratio can include dividing the teacher value by the student value. In some instances, an asymmetric (e.g. non-commutative, directional) divergence metric (e.g. Kullback-Leibler divergence) can be computed using an asymmetric (e.g. non-commutative) function of one or more student values and corresponding teacher values.

In some instances, the divergence metric can be computed by summing a plurality of comparison values across a plurality of subdivisions of the probability distribution. In some instances, computing a respective comparison value can include multiplying a log of a respective ratio by a respective reference value associated with the respective ratio.

In some instances, a divergence metric can include a metric that induces mode-seeking behavior when used in an objective function (e.g. a divergence metric wherein minimizing the divergence metric between a learned student probability distribution 210 and a teacher probability distribution 208 would cause a learned probability value to be zero whenever a corresponding teacher probability value is zero). In some instances, the divergence metric can correspond to a Kullback-Leibler divergence, a Jensen-Shannon divergence, a modified Kullback-Leibler divergence, or a modified Jensen-Shannon divergence. In some instances, a Kullback-Leibler divergence can be computed in either direction (e.g. from a teacher distribution 208 to a student distribution 210, or from a student distribution 210 to a teacher distribution 208). In some instances, the Kullback-Leibler divergence can be computed in a direction that induces mode-seeking behavior when used in an objective function. In some instances, this direction can be called “reverse KL,” and computing a “reverse KL” metric can include computing a sum over a vocabulary of (student probability value*log (student probability value divided by teacher probability value)), wherein a respective teacher probability value can be a probability value (e.g. a next-token prediction probability) associated with a token/vocabulary word in a teacher vocabulary, and a respective student probability value can be associated with a similar (e.g. same) token/vocabulary word in a student vocabulary that can be similar to (e.g. overlap with, be the same as) the teacher vocabulary.

In some instances, computing a divergence metric can include summing a plurality of comparison values across a plurality of subdivisions or bins of a distribution. In some instances, a comparison value can include or correspond to a ratio between a respective student probability value and a respective teacher probability value associated with a respective subdivision (e.g. log (student value/teacher value)). In some instances, a respective subdivision can be associated with a respective output candidate in an output space of the student model 104. In some instances, the first divergence can correspond to a Kullback-Leibler divergence or modified Kullback-Leibler divergence. In some instances, the first divergence can correspond to a Kullback-Leibler divergence from the student distribution 208 to the teacher distribution 210 or another distribution (e.g., mixture distribution comprising a mixture of the student distribution 208 and teacher distribution 210, etc.). An example KL divergence can be described as follows,

$${𝒟}_{K L} ( P \vert \vert Q ) = {\sum }_{c ∈ C} P ( c ) log \frac{P ( c )}{Q ( c )}$$

where P and Q are respective discrete distributions with C bins.

In some instances, a mixture-based divergence metric (e.g., Jensen-Shannon, etc.) can interpolate between mode-seeking and mean-seeking divergence metrics. For example, aligning a student distribution 208 to a teacher distribution 210 based on a mean-seeking divergence metric can cause the student distribution to learn to assign probability mass broadly over the output space, even for areas of the output space that might have low probability under the teacher distribution. This can increase a diversity of the output of the student model. However, for student models with relatively limited expressivity (as compared to the teacher model), a mode-seeking divergence metric can help the student model focus its expressivity on a narrower range of the output space around a mode of the teacher probability distribution. This can increase aspects of correctness of the student model by prioritizing alignment with higher-probability regions of the teacher distribution. However, focusing on a narrower range of the output space can decrease output diversity.

By allowing interpolation between mode-seeking and mean-seeking divergence metrics, a mixture-based divergence metric can allow for optimization of a diversity-performance tradeoff for various tasks. For example, creative tasks might prioritize diversity, so training a student model to be more creative can use a divergence metric configured to provide more mean-seeking behavior. Other tasks (e.g., data retrieval, generating tool calls for tool use, etc.) might benefit from higher accuracy or precision, so training such a student model can use a divergence metric configured to provide more mode-seeking behavior. In general, the balance of mode- and mean-seeking behavior can be optimized in training for various tasks. For example, a learnable hyperparameter can control such interpolation.

Computing a mixture-based divergence metric can include determining a mixture distribution and computing a first divergence metric between a student distribution and the mixture distribution. Computing the mixture-based divergence metric can include computing a second divergence between a teacher distribution and the mixture distribution. Computing the divergence metric can include combining the first and second divergence. In some instances, the mixture distribution can correspond to a mixture of a student probability distribution and a teacher probability distribution. An example mixture-based divergence metric can be described as follows:

$${𝒟}_{JSD ( β 〉} ( P \vert \vert Q ) = {β𝒟}_{KL} ( P \vert \vert β P + ( 1 - β ) Q ) + ( 1 - β ) {𝒟}_{KL} ( Q \vert \vert β P + ( 1 - β ) Q )$$

where beta indicates an interpolation parameter (e.g., which can be a learnable hyperparameter).

In some instances, the mixture distribution can be obtained by interpolating between a student distribution and a teacher distribution based on a weight (e.g., 0.1, 0.9, 0.5 etc.). In some instances, the mixture distribution can correspond to a weighted combination of a student distribution and a teacher distribution (e.g., 0.1*student+0.9*teacher, etc.). In some instances, the weight can be a hyperparameter that can be learned during training.

In some instances, evaluating a divergence metric based on the first divergence and second divergence can include computing a weighted combination of the first divergence and the second divergence. In some instances, the weight can be a hyperparameter that can be learned during training. In some instances, the weight used here can be the weight used to generate the mixture distribution. As an illustrative example, in some instances corresponding to a weight of 0.1, a mixture distribution can correspond to 0.1*student distribution 208+(1−0.1)*teacher distribution 210, and a weighted combination of divergences can correspond to (1−0.1)*first divergence+0.1*second divergence.

In some instances, a next token 216 can be, comprise, be comprised by, or otherwise share one or more properties with a next token 116. For example, in some instances, a next token 216 can have any property described herein with respect to a next token 116, and vice versa.

A sampling 218 component can be or include one or more software, firmware, or hardware components configured to sample a candidate next token 220 from a student probability distribution 210. In some instances, a sampling 218 component can be, comprise, be comprised by, or share one or more properties with a computing device or system described below with respect to FIGS. 12-14 (e.g., computing device 50, third-party system 80, computing device 98, computing device 99, etc.).

In some instances, a candidate next token 220 can be, comprise, be comprised by, or otherwise share one or more properties with a student value 108. For example, in some instances, a candidate next token 220 can have any property described herein with respect to a student value 108, and vice versa. Additionally, in some instances, a candidate next token 220 can have any property described herein with respect to a next token 116, and vice versa.

In some instances, a candidate next token 220 can be a member of a vocabulary (e.g., token vocabulary, word vocabulary, etc.) associated with a student probability distribution 210. In some instances, determining a candidate next token 220 can include sampling the candidate next token 220 from the student probability distribution 210 (e.g., wherein a probability of sampling each member of a plurality of members of a token vocabulary can be equal to a probability associated with that member in the student probability distribution 210, etc.).

A comparison 222 component can be or include one or more software, firmware, or hardware components configured to compare a candidate next token 220 to a teacher probability distribution 208, and to determine a next token 216 based on the comparison. In some instances, a comparison 222 component can be, comprise, be comprised by, or share one or more properties with a computing device or system described below with respect to FIGS. 12-14 (e.g., computing device 50, third-party system 80, computing device 98, computing device 99, etc.). In some instances, a computing device associated with a comparison 222 component can be the same device or a different device compared to a computing device associated with a sampling 218 component.

In some instances, determining whether to accept or reject a candidate next token 220 based on a comparison between the candidate next token 220 and the teacher probability distribution 208 can include accepting or rejecting based on one or more of: a probability associated with the candidate next token 220 in the teacher probability distribution 208; a ranking of the candidate next token 220 (e.g., ranking in an ordering from most probable to least probable, etc.) in the teacher probability distribution 208; or other comparison. Further details of an example system for accepting or rejecting candidate next token(s) 220 based on a ranking are provided below with respect to FIG. 3.

In some instances, a teacher model 102 can generate, in parallel, a plurality of teacher probability distributions 208 associated with a plurality of respective training iterations. For example, a student model 104 can generate, based on a current input context 106, a sequence of two or more (e.g., three, five, ten, etc.) consecutive candidate next tokens 220 (e.g., wherein each later candidate next token 220 of the sequence can be generated based in part on the earlier candidate next token(s) 220 of the sequence). The teacher model 102 can generate, in parallel, a plurality of teacher probability distributions 208 associated respectively with a plurality of current input contexts 106 associated with the sequence. For example, the teacher model 102 can generate, in parallel, one or more of: a first teacher probability distribution 210 generated based solely on the current input context 106 used by the student model 104 to generate the sequence; a second teacher probability distribution 208 generated based on the current input context 106 and a first token of the sequence generated by the student model 104; a third teacher probability distribution 208 generated based on the current input context 106, the first token, and a second token of the sequence generated by the student model 104; and so on. In some instances, a computing system 212 can determine (e.g., in parallel or sequentially, etc.), for each candidate next token 220 in the sequence generated by the student model 104, whether to accept or reject the candidate next token 220. In some instances, if a first candidate next token 220 is rejected, then the computing system 212 can automatically reject any remaining candidate next tokens 220 that are sequentially after the first candidate next token 220 in the sequence (e.g., any remaining candidate next tokens 220 that were generated based on the first candidate next token 220, etc.).

In some instances, the computing system 212 can determine a plurality of update 114 values in parallel. For example, in some instances, the computing system 212 can determine, for each respective teacher probability distribution 208 of a plurality of teacher probability distributions 208 that have been determined in parallel, an update 114 value based at least in part on the respective teacher probability distribution 208 (e.g., metric of divergence between the teacher probability distribution 208 and a corresponding student probability distribution 210 generated based on the same input context 106, etc.). In some instances, the computing system 212 can update (e.g., sequentially or in parallel, etc.) the student model 104 based on each update 114 value determined based on all or part of the sequence of candidate next tokens. As another example, in some instances, the computing system 212 can determine, for each accepted candidate next token 220, a teacher probability distribution 208 generated based on a current input context 106 including the accepted candidate next token; and update the student model 104 based on the teacher probability distribution 208. Continuing the example, in some instances, the computing system can discard each rejected candidate next token 220 without updating the student model 104 based on the rejected candidate next token 220, or the computing system 212 can update the student model 104 based on teacher probability distribution(s) 210 generated based in part on the rejected candidate next token 220.

In some instances, the teacher model 102 can generate a plurality of teacher distributions 210 (e.g., a plurality of teacher distributions 210 associated with a sequence of next tokens 116 or a sequence of candidate next tokens 220, etc.) re-using one or more computations. For example, in some instances, the teacher model 102 can generate two or more teacher distributions 210 without performing multiple forward inference passes. For example, a teacher model 102 can compute one or more matrices that store or encode meanings of, and relationships between, the current input context 106 (e.g., a KV cache of a transformer model). The teacher model 102 can use such values to compute a plurality of teacher probability distributions 210.

In this manner, for instance, example implementations of the present disclosure can decrease or avoid a computational cost of obtaining feedback from a teacher model 102 (e.g., which can be computationally more expensive to execute than the student model 104).

FIG. 3 is a block diagram of an example system for next token determination according to example implementations of aspects of the present disclosure. A computing system 312 can obtain (e.g., generate, receive, retrieve, etc.) a teacher probability distribution 208 and next token 220. The computing system 312 can perform a ranking 324 operation to determine a rank 326 of the candidate next token 220 within the teacher probability distribution 208. The computing system 312 can perform a threshold comparison 328 operation comparing the rank 326 to a rank threshold. Based on the comparison 328, the computing system can determine whether to use, as a next token 116, an accepted candidate token 316a or a resampled token 316b.

In some instances, a computing system 312 can be, comprise, be comprised by, or otherwise share one or more properties with a computing system 212. For example, in some instances, a computing system 312 can have any property described herein with respect to a computing system 212, and vice versa.

In some instances, an accepted candidate token 316a can be, comprise, be comprised by, or otherwise share one or more properties with a next token 116. For example, in some instances, an accepted candidate token 316a can have any property described herein with respect to a next token 116, and vice versa. Additionally, in some instances, an accepted candidate token 316a can be, comprise, be comprised by, or otherwise share one or more properties with a candidate next token 220. For example, in some instances, an accepted candidate token 316a can have any property described herein with respect to a candidate next token 220, and vice versa. In some instances, an accepted candidate token 316a can include a candidate next token 220 that has been accepted for inclusion in the input context 106 (e.g., accepted for inclusion as a next input token 116 in a next iteration of a plurality of training iterations, etc.).

In some instances, a resampled token 316b can be, comprise, be comprised by, or otherwise share one or more properties with a next token 116. For example, in some instances, a resampled token 316b can have any property described herein with respect to a next token 116, and vice versa. In some instances, a resampled token 316b can include a next token 116 that has been selected to replace a rejected candidate next token 220. In some instances, determining a resampled token 316b can include one or more methods that are similar to (e.g., same as) or different from a method for determining a candidate next token 220 or accepted candidate next token 316a. For example, in some instances, determining a resampled token 316b can include sampling a token from the teacher probability distribution 208. As another example, in some instances, determining a resampled token 316b can include sampling a new candidate next token 220 from the student probability distribution 210, and accepting or rejecting the new candidate next token 220 (e.g., according to methods described herein for accepting or rejecting a first candidate next token 220, etc.). As another example, in some instances, determining a resampled token 316b can include sampling from another probability distribution, such as a probability distribution determined based on a combination of the student probability distribution 210 and teacher probability distribution 208. As a non-limiting illustrative example, an alternative probability distribution can include a probability distribution determined by identifying a top K tokens associated with a top K teacher probability 208 values; assigning a probability of zero to each token outside the teacher top-K and assigning a student probability 210 value to each token inside the teacher top-K; and normalizing the resulting values so that the resulting probability distribution sums to one. As another non-limiting illustrative example, an alternative probability distribution can include a normalized combination of the student and teacher probability distributions 208, 210, such as a normalized product; normalized weighted product; normalized weighted sum; or the like. Other examples are possible.

A ranking 324 component can be or include one or more software, firmware, or hardware components configured to determine a rank 326 of the candidate next token 220 with respect to a teacher probability distribution 208. In some instances, the ranking 324 component can be, comprise, be comprised by, or share one or more properties with a computing device or system described below with respect to FIGS. 12-14 (e.g., computing device 50, third-party system 80, computing device 98, computing device 99, etc.).

A rank 326 can generally include or otherwise represent various types of data. A rank 324 can include, for example, numerical data (e.g., integer data, etc.), such as data indicative of a rank of the candidate next token 220 in an ordered ranking of the teacher probability distribution For example, in some instances, a rank 326 can include a rank (e.g., index, location, etc.) of the candidate next token 220 in an ordering (e.g., ordered collection such as list, array, etc.) of token-probability pairs associated with the teacher probability distribution 208, wherein the ordering can be based at least in part on probability values of the token-probability pairs (e.g., ascending or descending order or probability, etc.). Other rankings are possible without deviating from the scope of the present disclosure. For example, in some instances, a rank 326 can include data indicative of a rank of the candidate next token 220 in an ordered ranking of score values, wherein each score value is determined based at least in part on a corresponding probability value of the teacher probability distribution 208 (e.g., and based in part on one or more other values, etc.).

A threshold comparison 328 component can be or include one or more software, firmware, or hardware components configured to compare a rank 326 of the candidate next token 220 to a rank threshold. In some instances, the threshold comparison 328 component can be, comprise, be comprised by, or share one or more properties with a computing device or system described below with respect to FIGS. 12-14 (e.g., computing device 50, third-party system 80, computing device 98, computing device 99, etc.). In some instances, a computing device associated with a threshold comparison 328 component can be the same device or a different device compared to a computing device associated with a ranking 324 component.

In some instances, a threshold comparison 328 can include a comparison between a rank 326 of the candidate next token 220 and a threshold rank (e.g., 25, 50, etc.). For example, in some instances, a candidate next token 220 can be accepted if its rank 326 indicates that the candidate next token 220 is associated with an equal or higher probability in the teacher probability distribution 208 compared to a token of the threshold rank. As a non-limiting illustrative example, if a threshold rank is 25, an eighth-highest-probability token can be accepted, as eight is less than or equal to 25. In other words, in some instances, a candidate next token 220 can be accepted if it is within a top K highest-probability tokens of the teacher probability distribution 208 (or highest-score probability tokens of a distribution of weighted scores, etc.), and rejected otherwise, wherein K is a positive integer indicative of a threshold rank. In some instances, the rank threshold can be a hyperparameter associated with the training process. In some instances, a rank threshold can include a parameter that adaptively changes (e.g., increases, decreases, etc.) as training progresses, such as according to a process that increases a rate of accepting candidate next tokens 220 as a student model 104 becomes more accurate or as a training process comes closer to a training endpoint (e.g., last iteration of a fixed number of iterations, etc.).

Although FIG. 3 depicts accepting or rejecting candidate tokens based on a rank threshold, other implementations are possible. For example, in some instances, a candidate next token 220 can be accepted or rejected based on a teacher probability value threshold (e.g., fixed probability value irrespective of how many tokens of the teacher probability distribution 210 have a probability value above the threshold, etc.); based on a score threshold (e.g., threshold associated with a weighted score determined based at least in part on a teacher probability value associated with the candidate next token 220); or other method of acceptance or rejection.

### Example Methods

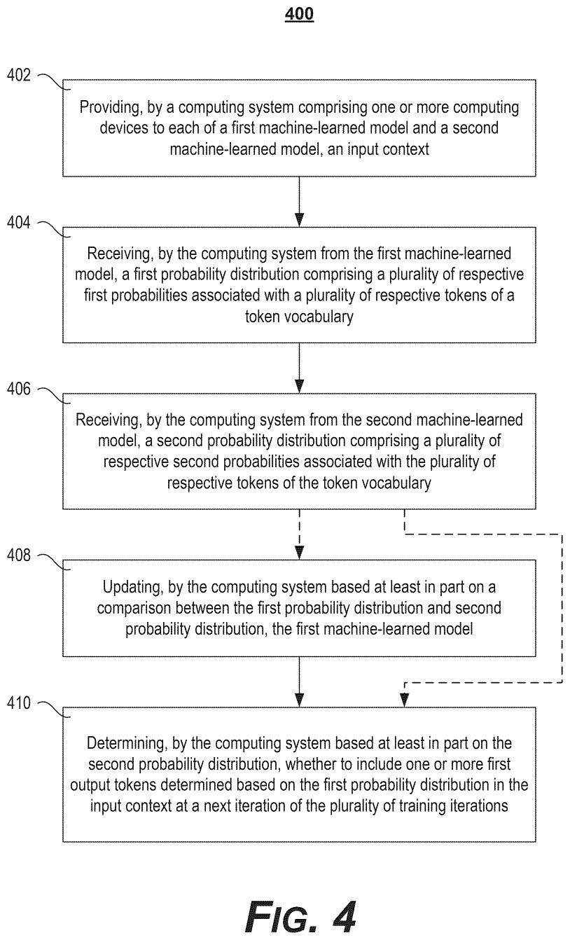

FIG. 4 depicts a flowchart diagram of an example method for performing an iteration of a multi-iteration training process according to example embodiments of the present disclosure. Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include providing, by a computing system (e.g., training system 112, etc.) comprising one or more computing devices to each of a first machine-learned model (e.g., student model 104, etc.) and a second machine-learned model (e.g., teacher model 102, etc.), an input context (e.g., current input context 106, etc.). In some instances, example method 400 at 402 can include using one or more systems or performing one or more activities described with respect to FIGS. 1-3.

At 404, example method 400 can include receiving, by the computing system from the first machine-learned model, a first probability distribution (e.g., student probability distribution 210, etc.) comprising a plurality of respective first probabilities associated with a plurality of respective tokens of a token vocabulary. In some instances, example method 400 at 404 can include using one or more systems or performing one or more activities described with respect to FIGS. 1-3.

At 406, example method 400 can include receiving, by the computing system from the second machine-learned model, a second probability distribution (e.g., teacher probability distribution 208, etc.) comprising a plurality of respective second probabilities associated with the plurality of respective tokens of the token vocabulary. In some instances, example method 400 at 406 can include using one or more systems or performing one or more activities described with respect to FIGS. 1-3.

At 408, example method 400 can include updating, by the computing system based at least in part on a comparison between the first probability distribution and second probability distribution, the first machine-learned model. In some instances, example method 400 at 408 can include using one or more systems or performing one or more activities described with respect to FIGS. 1-3.

At 410, example method 400 can include determining, by the computing system based at least in part on the second probability distribution, whether to include one or more first output tokens (e.g., candidate next tokens 220, etc.) determined based on the first probability distribution in the input context at a next iteration of the plurality of iterations. In some instances, example method 400 at 410 can include using one or more systems or performing one or more activities described with respect to FIGS. 1-3.

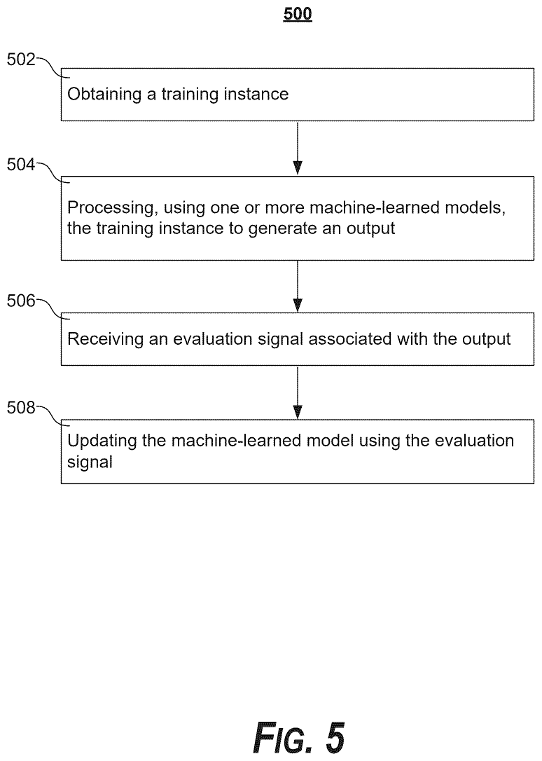

FIG. 5 depicts a flowchart of a method 500 for training one or more machine-learned models according to aspects of the present disclosure. For instance, an example machine-learned model can include a student model 104 or teacher model 102.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types. In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), chemical or biochemical data, image data, audio data, audiovisual data, haptic data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and astronomical data, sensor data and chemical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

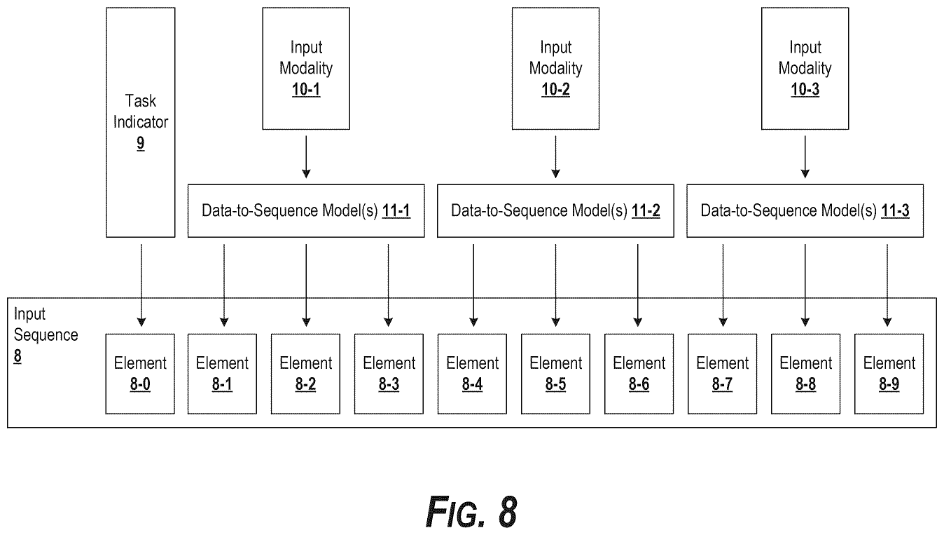

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

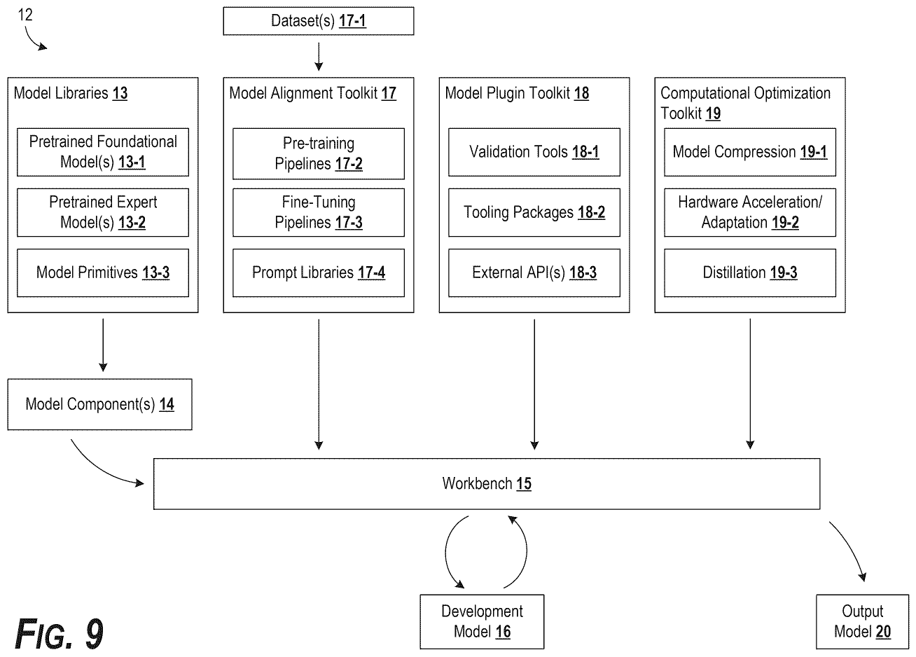

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine—learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

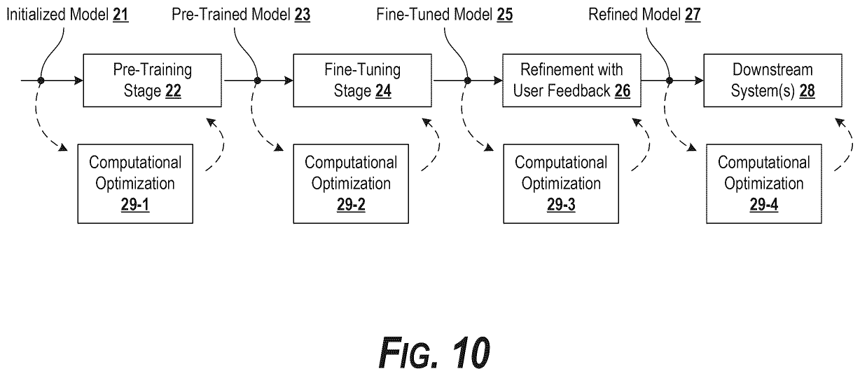

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

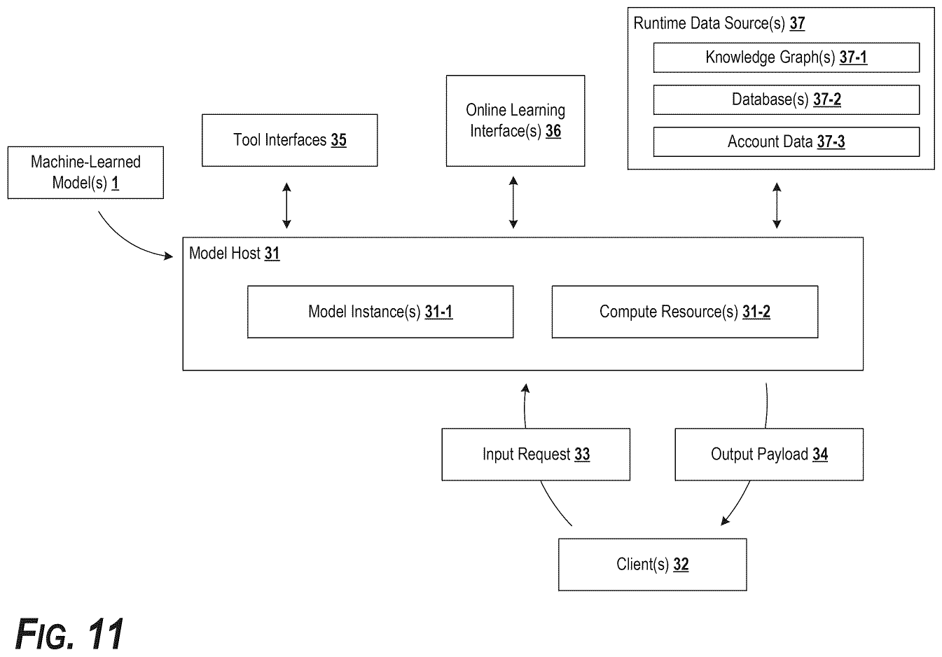

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

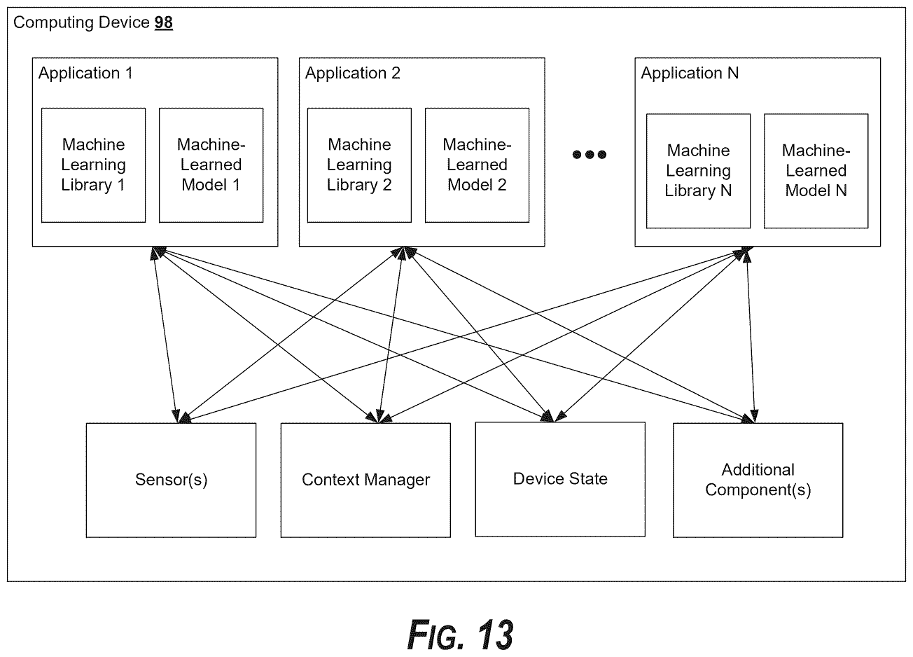

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

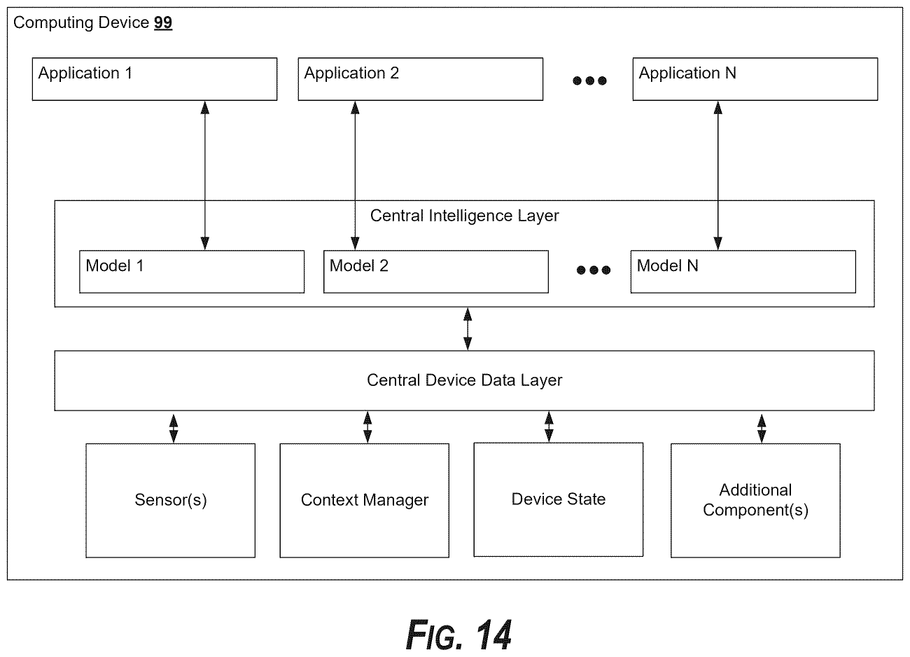

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method comprising:
for each of a plurality of training iterations:
providing, by a computing system comprising one or more computing devices to each of a first machine-learned model and a second machine-learned model, an input context;
receiving, by the computing system from the first machine-learned model, a first probability distribution comprising a plurality of respective first probabilities associated with a plurality of respective tokens of a token vocabulary;
receiving, by the computing system from the second machine-learned model, a second probability distribution comprising a plurality of respective second probabilities associated with the plurality of respective tokens of the token vocabulary;
determining, by the computing system based at least in part on the second probability distribution, whether to include one or more first output tokens determined based on the first probability distribution in the input context at a next iteration of the plurality of training iterations; and
performing at least one of:
adding, to the input context by the computing system responsive to determining that the one or more first output tokens should not be included in the input context at the next iteration, one or more second tokens different from the one or more first output tokens; and
adding, to the input context by the computing system responsive to determining that the one or more first output tokens should be included in the input context at the next iteration, the one or more first output tokens.

2. The method of claim 1, further comprising updating, at one or more of the plurality of training iterations, by the computing system based at least in part on a comparison between the first probability distribution and second probability distribution, the first machine-learned model.

3. The method of claim 2, wherein updating the first machine-learned model comprises updating based on a metric of divergence between the first probability distribution and the second probability distribution.

4. The method of claim 1, wherein determining whether to include the one or more first output tokens in the input context at the next iteration comprises one or more of:
comparing, by the computing system, a ranking of the one or more first output tokens within the second probability distribution to a ranking threshold; and
comparing, by the computing system, a probability associated with the one or more first output tokens in the second probability distribution to a probability threshold.

5. The method of claim 1, wherein the one or more second tokens are determined by sampling, by the computing system, the one or more second tokens from the second probability distribution.

6. The method of claim 1, wherein the one or more second tokens are determined by:
sampling, by the computing system, the one or more second tokens from the first probability distribution; and
determining, by the computing system based at least in part on the second probability distribution, whether to include the one or more second tokens in the input context at the next iteration.

7. The method of claim 1, wherein the first machine-learned model has been pretrained based on a first training dataset prior to the plurality of training iterations.

8. The method of claim 7, wherein the first machine-learned model has been further trained based on a second training dataset prior to the plurality of training iterations.

9. The method of claim 1, comprising performing two or more training iterations of the plurality of training iterations in parallel by:
generating, by the first machine-learned model based at least in part on the input context, a sequence comprising a plurality of candidate output tokens associated with the two or more training iterations;
generating, by the second machine-learned model based on the sequence, a plurality of second probability distributions in parallel;
determining, by the computing system based at least in part on the plurality of second probability distributions, whether to include a first candidate output token of the plurality of candidate output tokens in the input context at a later iteration of the plurality of training iterations; and
performing at least one of:
determining, by the computing system responsive to determining that the first candidate output token should be included in the input context at the later iteration, based at least in part on the plurality of second probability distributions, whether to include a second candidate output token of the plurality of candidate output tokens in the input context at the later iteration; and
discarding, by the computing system responsive to determining that the first candidate output token should not be included in the later iteration, the first candidate output token and the second candidate output token.

10. The method of claim 1, wherein:
the first machine-learned model is characterized by a first number of parameters;
the second machine-learned model is characterized by a second number of parameters; and
the second number of parameters is larger than the first number of parameters.

11. The method of claim 10, wherein the second number of parameters is at least three times the first number of parameters.

12. A computing system comprising one or more processors and one or more non-transitory computer-readable media storing instructions that are executable by one or more processors to cause the computing system to perform operations, the operations comprising:
for each of a plurality of training iterations:
providing, to each of a first machine-learned model and a second machine-learned model, an input context;
receiving, from the first machine-learned model, a first probability distribution comprising a plurality of respective first probabilities associated with a plurality of respective tokens of a token vocabulary;
receiving, from the second machine-learned model, a second probability distribution comprising a plurality of respective second probabilities associated with the plurality of respective tokens of the token vocabulary;
determining, based at least in part on the second probability distribution, whether to include one or more first output tokens determined based on the first probability distribution in the input context at a next iteration of the plurality of training iterations; and
performing at least one of:
adding, to the input context responsive to determining that the one or more first output tokens should not be included in the input context at the next iteration, one or more second tokens different from the one or more first output tokens; and
adding, to the input context responsive to determining that the one or more first output tokens should be included in the input context at the next iteration, the one or more first output tokens.

13. The computing system of claim 12, wherein the operations further comprise updating, at one or more of the plurality of training iterations based at least in part on a comparison between the first probability distribution and second probability distribution, the first machine-learned model.

14. The computing system of claim 13, wherein updating the first machine-learned model comprises updating based on a metric of divergence between the first probability distribution and the second probability distribution.

15. The computing system of claim 12, wherein determining whether to include the one or more first output tokens in the input context at the next iteration comprises one or more of:
comparing a ranking of the one or more first output tokens within the second probability distribution to a ranking threshold; and
comparing a probability associated with the one or more first output tokens in the second probability distribution to a probability threshold.

16. The computing system of claim 12, wherein the one or more second tokens are determined by sampling the one or more second tokens from the second probability distribution.

17. The computing system of claim 12, wherein the one or more second tokens are determined by:
sampling the one or more second tokens from the first probability distribution; and
determining, based at least in part on the second probability distribution, whether to include the one or more second tokens in the input context at the next iteration.

18. The computing system of claim 12, wherein the operations comprise performing two or more training iterations of the plurality of training iterations in parallel by:
generating, by the first machine-learned model based at least in part on the input context, a sequence comprising a plurality of candidate output tokens associated with the two or more training iterations;
generating, by the second machine-learned model based on the sequence, a plurality of second probability distributions in parallel;
determining, by the computing system based at least in part on the plurality of second probability distributions, whether to include a first candidate output token of the plurality of candidate output tokens in a later iteration of the plurality of training iterations; and
performing at least one of:
determining, responsive to determining that the first candidate output token should be included in the input context at the later iteration, based at least in part on the plurality of second probability distributions, whether to include a second candidate output token of the plurality of candidate output tokens in the input context at the later iteration; and
discarding, responsive to determining that the first candidate output token should not be included in the later iteration, the first candidate output token and the second candidate output token.

19. The computing system of claim 12, wherein:
the first machine-learned model is characterized by a first number of parameters;
the second machine-learned model is characterized by a second number of parameters; and
the second number of parameters is larger than the first number of parameters.

20. One or more non-transitory computer-readable media storing instructions that are executable by one or more processors to cause a computing system to perform operations, the operations comprising:
for each of a plurality of training iterations:
providing, to each of a first machine-learned model and a second machine-learned model, an input context;
receiving, from the first machine-learned model, a first probability distribution comprising a plurality of respective first probabilities associated with a plurality of respective tokens of a token vocabulary;
receiving, from the second machine-learned model, a second probability distribution comprising a plurality of respective second probabilities associated with the plurality of respective tokens of the token vocabulary;
determining, based at least in part on the second probability distribution, whether to include one or more first output tokens determined based on the first probability distribution in the input context at a next iteration of the plurality of training iterations; and
performing at least one of:
adding, to the input context responsive to determining that the one or more first output tokens should not be included in the input context at the next iteration, one or more second tokens different from the one or more first output tokens; and
adding, to the input context responsive to determining that the one or more first output tokens should be included in the input context at the next iteration, the one or more first output tokens.
